(19) United States
(12) Patent Application Publication
(10) Pub. No.: US 2023/0219359 A1
(43) Pub. Date: Jul. 13, 2023

(54) PACKAGING PRINT MEDIA

(71) Applicant: Hewlett-Packard Development Company, L.P., Spring, TX (US)

(72) Inventors: Xiaoqi Zhou, San Diego, CA (US); Xulong Fu, San Diego, CA (US); Tao Chen, San Diego, CA (US)

(73) Assignee: Hewlett-Packard Development Company, L.P., Spring, TX (US)

(21) Appl. No.: 18/009,931

(22) PCT Filed: Jun. 25, 2020
(86) PCT No.: PCT/US2020/039529

§ 371 Date: Dec. 12, 2022

(51) Int. Cl. B41M 5/50; B41M 5/52; C09D 103/02; C09D 11/54

(52) U.S. Cl. CPC B41M 5/504; B41M 5/506; B41M 5/508; B41M 5/5236; B41M 5/5254; C09D 103/02; C09D 11/54; B41M 5/5218

(57) ABSTRACT

A packaging print medium can include a cellulose-based substrate having a printing side and a back side, a fixative sizing layer on a printing side of the cellulose-based substrate, a primer layer on the back side of the cellulose-based substrate, and a hydrophobic moisture barrier including a hydrophobic polymer film on the primer layer. The fixative sizing layer can have a thickness from 0.5 μm to 15 μm and can include a multivalent metal salt and a starch sizing agent. The primer layer can have a thickness from 0.5 μm to 15 μm and can include a styrene-butadiene film. The hydrophobic moisture barrier can have a thickness from 0.5 μm to 10 μm.

### BACKGROUND

There are several reasons that inkjet printing has become a popular way of recording images on various medium surfaces, particularly paper. Some of these reasons include low printer noise and capability of high-speed recording (or printing), reduced job turnaround time, improved competitiveness in the context of commercial printing, or the like. High speed printing applications, for example, can provide many benefits. Providing good ink absorption and/or fast dry time while retaining good gloss is a combination that is useful in the context of high speed printing, for example.

### BRIEF DESCRIPTION OF THE DRAWINGS

FIG. 1 is a schematic cross-sectional view of an example packaging print medium in accordance with the present disclosure;

FIG. 2 is a schematic cross-sectional view of an example packaging print medium with a printed image and a transparent abrasion-resistant layer thereon in accordance with the present disclosure;

FIG. 3 is a schematic view of an example packaging print medium being prepared using an in-line coating (and printing) apparatus in accordance with the present disclosure;

FIG. 4 is a flow diagram representing an example method of making a packaging print medium in accordance with examples of the present disclosure; and

FIG. 5 is a flow diagram representing an example method of printing in accordance with examples of the present disclosure.

### DETAILED DESCRIPTION

In accordance with examples of the present disclosure, packaging media can be prepared that incudes multiple barriers for ameliorating the transmission of moisture and/or moisture vapor, and that can be printable using an aqueous ink composition, for example. By using a fixative coating to be applied with an ink for imaging on one side, and including multiple moisture-resistant coatings on the other side, a cellulose-based media substrate can be modified for both printability and for moisture resistance.

In accordance with this, a packaging print medium, in one example, includes a cellulose-based substrate having a printing side and a back side, a fixative sizing layer on a printing side of the cellulose-based substrate, a primer layer on the back side of the cellulose-based substrate, and a hydrophobic moisture barrier including a hydrophobic polymer film on the primer layer. The fixative sizing layer in this example has thickness from 0.5 μm to 15 μm and includes a multivalent metal salt and a starch sizing agent. The primer layer in this example has a thickness from 0.5 μm to 15 μm and includes a styrene-butadiene film. The hydrophobic moisture barrier in this example has a thickness from 0.5 μm to 10 μm. The multivalent metal salt of the fixative sizing layer can include a Group II metal salt, Group III metal salt, transitional metal salt, or a combination thereof. In one example, the primer layer can include moisture-repelling particles dispersed (or homogenously blended) in the styrene-butadiene film, and can include from 1 wt % to 15 wt % wax particles, from 1 wt % to 75 wt % inorganic particles, or a combination thereof, based on a total dry weight of the primer layer. The styrene-butadiene film can have a molar ratio of styrene moieties to butadiene moieties from 3:1 to 1:3. The hydrophobic polymer film of the hydrophobic moisture barrier can include polymer with C1 to C8 fluorocarbon moieties, polysiloxane, polyolefin, or a combination thereof. The hydrophobic moisture barrier may also include moisture-repellant particles dispersed therein at a dry weight ratio from 1:3 to 20:1. In some examples, the packaging print medium can include a transparent abrasion-resistant layer on the fixative sizing layer. The transparent abrasion-resistant layer can include, for example, polyacrylate-based polymer, polymethacrylate-based polymer, wax, or a combination thereof. The transparent abrasion-resistant layer can also be applied on an ink composition that is present on the fixative sizing layer.

In another example, a method of preparing a packaging print medium includes treating a cellulose-based substrate at a printing side thereof with a fixative sizing layer having a thickness from 0.5 μm to 15 μm and including a multivalent metal salt and a starch sizing agent; coating a back side of the cellulose-based substrate with a primer layer having a thickness from 0.5 μm to 15 μm and including a styrene-butadiene film; and coating the primer layer with a hydrophobic moisture barrier having a thickness from 0.5 μm to 10 μm and including a hydrophobic polymer film. In one example, the method can include printing an ink composition on the printing side to contact the fixative sizing layer, and in some examples, the method can further include applying a transparent protective layer over the ink composition.

In another example, a method of printing includes ejecting an ink composition on a packaging print medium and applying a transparent protective layer over the ink composition. The packaging print medium in this example includes a cellulose-based substrate having a printing side and a back side, a fixative sizing layer on a printing side of the cellulose-based substrate, a primer layer on the back side of the cellulose-based substrate, and a hydrophobic moisture barrier including a hydrophobic polymer film on the primer layer. The fixative sizing layer in this example has a thickness from 0.5 μm to 15 μm and includes a multivalent metal salt and a starch sizing agent. The primer layer in this example has a thickness from 0.5 μm to 15 μm and includes a styrene-butadiene film. The hydrophobic moisture barrier in this example has a thickness from 0.5 μm to 10 μm. In one example, the ink composition can be a pigment-based ink composition including a pigment colorant that is reactive with the multivalent salt of the fixative sizing layer. The transparent abrasion-resistant layer can include, for example, polyacrylate-based polymer, polymethacrylate-based polymer, wax, or a combination thereof.

It is noted that when discussing the packaging print media and associated methods, these descriptions can be considered applicable to the other examples, whether or not they are explicitly discussed in the context of that example. Thus, for example, in discussing examples of a hydrophobic moisture barrier in the context of a packaging print medium, such examples can also be applicable to the methods, and vice versa.

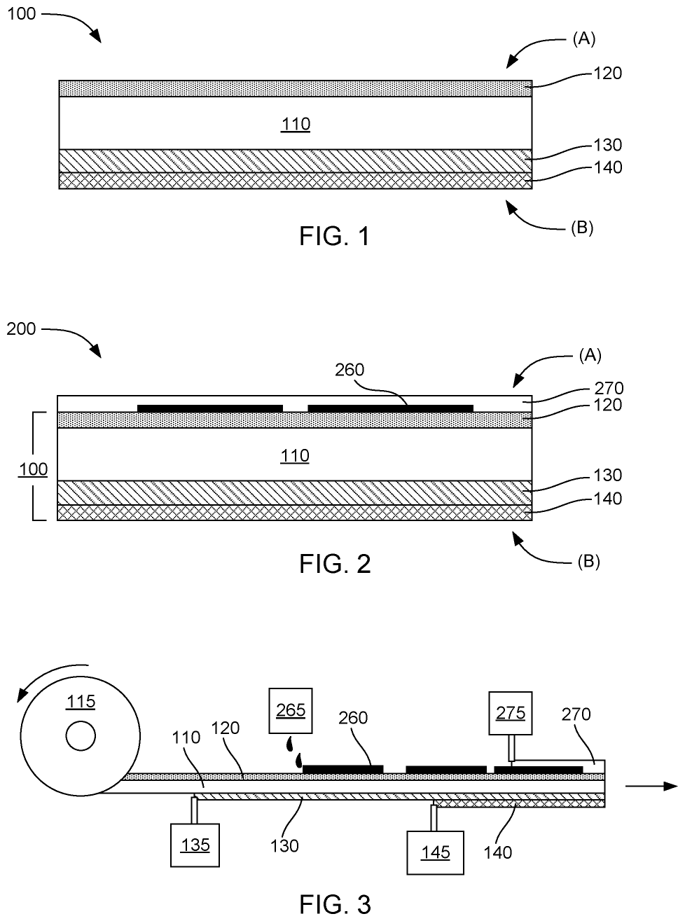

Turning now to the specific components and structures of the print media, several materials have been briefly described and will be described in greater detail hereinafter. FIGS. 1-3 depict example print media that can be prepared or are being prepared in accordance with the present disclosure.

FIG. 1 is a packaging print medium 100 with a cellulose-based substrate 110 having a printing side (A) and a back side (B), a fixative sizing layer 120 on a printing side of the cellulose-based substrate, a primer layer 130 on the back side of the cellulose-based substrate, and a hydrophobic moisture barrier 140 including a hydrophobic polymer film on the primer layer.

FIG. 2 also depicts a packaging print medium 200 with a cellulose-based substrate 110 having a printing side (A) and a back side (B), a fixative sizing layer 120 on a printing side of the cellulose-based substrate, a primer layer 130 on the back side of the cellulose-based substrate, and a hydrophobic moisture barrier 140 including a hydrophobic polymer film on the primer layer. Thus, the packaging print medium shown at 100 can be similar to that shown in FIG. 1. However, as shown in FIG. 2, there is also an ink composition 260 applied as a printed image or printed matter to the fixative sizing layer, and there is also a transparent abrasion-resistant layer 270 applied over the fixative sizing layer and the ink composition.

FIG. 3 illustrates one preparative example of how the packaging print medium may be prepared, and in this example, printed on and coated for protection. In this example, a roll 115 of cellulose-based substrate 110 that is pre-coated with a fixative sizing layer 120 is fed in-line through a coating and printing apparatus where a primer layer 130, a hydrophobic moisture barrier 140 and a transparent abrasion-resistant layer 270 can be applied as shown using various analog coating apparatuses 135, 145, and 275, respectively. During the coating process, an ink composition 260 can be applied as printed indicia or matter on the fixative sizing layer to be subsequently coated by the transparent abrasion-resistant layer. This is a single example of an in-line coating and printing apparatus, however, there could be other arrangements, such as arrangements where the fixative sizing layer is also applied in-line, or where the various coating layers are applied by separate devices, etc. Thus, this arrangement should not be considered limiting. Regarding the various application layers shown and described in the FIGS. and elsewhere in the specification, the various layers can have various compositional components, layer properties, thickness, and/or the like.

### Cellulose-Based Substrates

Turning now to more detail regarding the cellulose-based substrate, these substrates can include mostly paper fibers made by either using a chemical or mechanical pulping process to yield wood fiber from different types of trees, e.g., greater than 50 wt % cellulose material. Chemical pulp, or fibers processed through chemical treatment, can often have better strength and make whiter base media with better light resistance. Mechanical pulp, or fibers processed using mechanical force, may have weak paper strength, but higher opacity, also tending to turn yellow over time with UV exposure. The different fiber combinations and fiber refining processes can have an impact on the fixative sizing layer designed for digital presses or other printing systems, for example.

The cellulose-based substrate can be an uncoated base stock, or can be a coated base stock, for example. For example, the cellulose-based substrate can be a cellulose base stock made from cellulose fiber pulp. In this example, the cellulose fiber pulp portion can include, for example, from 0 wt % to 30 wt % mechanical pulp, with less than 100 wt % chemical pulp being present as a maximum. In another example, the fiber pulp can include from 30 wt % to 100 wt % mechanical pulp, from 50 wt % to 100 wt % mechanical pulp, from 75 wt % to 100 wt % mechanical pulp, from 90 wt % to 100 wt % mechanical pulp, or with 100 wt % mechanical pulp. One benefit of papers containing mechanical pulp is good opacity, even at low basis weight. Other advantages can include lower cost compared to chemical pulp. Chemical pulp can likewise be used or be present in some examples. Mechanical pulp can be used with chemical pulp with the mechanical pulp having coating layers that may not have as much covering power as other thicker coatings. In some examples, discoloration may not be of a particular concern, and thus, the cheaper option can be chosen. By using some chemical pulp, less yellowing of the base stock may be present, and a whiter and more optically bright coated packaging print medium can be prepared that lasts for a more extended period of time, even with the use of thinner and/or less expensive coatings. However, for certain paper projects, if yellowing or grayer base stock media is not a problem, and other considerations such as cost reduction, etc., are desired, less or no chemical pulp may be present, e.g., newsprint-type publication jobs where the life cycle of the printed products is limited.

In further detail, the cellulose-based substrate can include, for example, a relatively high concentration of wood fiber, including softwood and/or hardwood fiber content. This can in some instances assist in keeping the substrate absorptive. In one example, the softwood fibers can make up the entire wood fiber content, or alternatively, the hardwood fibers can make up the entire wood fiber content. In still other examples, a blend of any proportion of softwood to hardwood can be present, but in one example, the softwood to hardwood range can be from 30:70 to 1:99 by weight. In one specific example, a blend of softwood fiber to hardwood fiber can be from 40:60 to 60:40, or in another example, at about 50:50, by weight. As used herein, the term “wood fiber(s)” refers to cellulosic fibers and other known paper fibers including hardwood pulps and softwood pulps as defined herein. As used herein, the term “hardwood fiber” or “hardwood pulps” refers to fibrous pulp derived from the woody substance of deciduous trees (angiosperms) such as aspen, birch, oak, beech, maple, and eucalyptus. As used herein, the term “softwood fiber” or “softwood pulps” refers to fibrous pulps derived from the woody substance of coniferous trees (gymnosperms) such as varieties of fir, spruce, and pine, as for example loblolly pine, slash pine, Colorado spruce, balsam fir and Douglas fir.

Thus, the cellulose paper base can be made of any suitable wood or non-wood pulp. Non-limitative examples of suitable pulp compositions include, but are not limited to, mechanical wood pulp, chemically ground pulp, chemi-mechanical pulp, thermo-mechanical pulp (TMP) and combinations of one or more of the above. In some examples, the cellulose paper web comprises a bleached hardwood chemical kraft pulp. The bleached hardwood chemical kraft pulp contains more than 70% by weight, for example, of hardwood fibers in total fiber content, which has a shorter fiber structure (about 0.3 to about 0.6 mm length) than soft wood pulp. The shorter fiber structure contributes to good formation of the paper product in roll or sheet form, for example.

The cellulose-based substrate can also include other additives or “filler” other than mechanical and/or chemical pulps, such as inorganic filler (similar to the inorganic particulates that may be used in the fixative sizing layer), internal sizing agents, etc. Examples of inorganic filler may likewise include precipitated calcium carbonate, ground calcium carbonate, clay, talc, titanium dioxide, kaolin clay, silicates, plastic pigment, alumina trihydrate, etc. Other additives that may be present in the cellulose-based substrate include internal sizing additives, dry or wet strength agents, dyes, optical brightening agents, etc. Internal sizing agents that may be used include any of those used at the wet end of a paper manufacturing machine and selected to retain the open structure of the cellulose-based substrate. For example, small amounts of rosin; rosin precipitated with alum (Al₂(SO₄)₃); abietic acid and abietic acid homologues such as neoabietic acid and levopimaric acid; stearic acid and stearic acid derivatives; ammonium zirconium carbonate; silicone and silicone-containing compounds; fluorochemicals of the general structure CF₃(CF₂)ₙR, wherein R is anionic, cationic or another functional group and n can range from 1 to 1000; starch and starch derivatives; methyl cellulose; carboxymethylcellulose (CMC); polyvinyl alcohol; alginates; waxes; wax emulsions; alkylketene dimmer (AKD); alkenyl ketene dimer emulsion (AnKD); alkyl succinic anhydride (ASA); emulsions of ASA or AKD with cationic starch; ASA incorporating alum; and/or other internal sizing agents; and mixtures thereof. The degree of internal sizing may be characterized by Hercules Sizing Test (HST) value per Tappi method T530. In some examples, the cellulose-based paper web has an internal sizing with a low HST value ranging from 1 to 50, e.g., a soft internal sizing. In other examples, the HST value ranges from about 1 to about 10.

In one example, the cellulose-based substrate can be prepared or selected with lower levels of additives or filler, which can be selected that allow for good absorption to provide a more open paper structure to receive ink composition through the fixative sizing layer. An amount of the filler in the pulp may include as much as 20 percent (%) by weight, for example. In some examples, the amount of filler in the pulp ranges from about 0% to about 20% of the paper product in roll or sheet form. In another example, the amount of filler ranges from about 5% to about 15% of the paper product in roll or sheet form. In some examples, if the percentage of filler is more than 20% by weight, pulp fiber-to-fiber bonding may be reduced, which subsequently may decrease stiffness and strength of the resulting paper product in roll or sheet form.

The cellulose-based substrate can have a basis weight from 35 grams per square meter (gsm) to 250 gsm, from 50 gsm to 200 gsm, from 50 gsm to 150 gsm, or from 75 gsm to 250 gsm, for example.

### Fixative Sizing Layers

A multivalent metal salt can be included as a fixative compound to be included in the fixative treatment layer, as previously mentioned. The fixative treatment layer can be applied during the paper making process, or can be applied by the user of the print media for application of the other layers and barriers (and ink compositions in some instances). The multivalent metal salts in these examples can provide good image quality when used with aqueous ink compositions, including pigmented ink compositions. However, metal salts can sometimes lead to lower gloss of the fixative sizing layer as the colorant (of the ink printed thereon) crashes or otherwise interacts with the metal salt. Other components herein can help alleviate this reduced gloss to some degree, and as the metal salt provides good crispness, edge-acuity, and the like, this is a tradeoff that can be worth accepting with appropriate gloss enhancement using other components, such as the emulsifier described herein. Furthermore, as noted below in more detail, the transparent abrasion-resistant layer can also provide enhanced gloss in some instances.

The metal salt can be a multivalent metal salt, and examples include Group II or alkaline earth metals, e.g., calcium or magnesium, as well as any of a number of transition metals, such as copper, nickel, aluminum, etc., as well as Group III metals, such as aluminum. In liquid or composition form (when prepared for application), the multivalent metal salts can be associated with an anionic counter ion, which can be chloride, iodide, bromide, nitrate, sulfate, sulfite, phosphate, chlorate, acetate, formate, or other similar counter ions and various combinations thereof. Specific examples thereof include barium chloride, calcium chloride, calcium acetate, calcium nitrate, calcium formate, magnesium chloride, manganese sulfate, magnesium nitrate, magnesium acetate, magnesium formate, zinc chloride, zinc sulfate, zinc nitrate, zinc formate, tin chloride, tin nitrate, manganese chloride, manganese sulfate, manganese nitrate, manganese formate, aluminum sulfate, aluminum nitrate, aluminum chloride, aluminum acetate, or the like. These metal salts may be used alone or in combinations of salts. The metal salt can be included in the fixative sizing layer at from 2 wt % to 30 wt %, from 2 wt % to 20 wt %, or from 5 wt % to 20 wt %, for example.

In addition to the multivalent salt component, there can be other components present as well, such as a starch sizing agent and any fillers that may be included. For example, the various components in the fixative sizing layer can be bound together and applied to adhere to the cellulose-based substrate due to the presence of a water-soluble starch sizing agent, for example. The starch sizing agent may provide good coating cohesiveness and adherence to the cellulose-based substrate, and where more durability is desired, the transparent abrasion-resistant layer can be applied to ink compositions printed thereon. Example components that may also be included, in addition to the multivalent salt and the starch sizing agent, may be optical brightener, pH adjustment agent, or the like.

The fixative sizing layer can be applied, for example, at a weight basis from 1 gsm to 15 gsm, from 2 gsm to 15 gsm, from 2 gsm to 8 gsm, or from 3 gsm to 8 gsm, for example. The thickness can be from 0.5 μm to 15 μm, from 1 μm to 15 μm, from 2 μm to 15 μm, from 2 μm to 8 μm, or from 3 μm to 8 μm, for example. Application can be by use of an on-line surface size press process such as a puddle-sized press or a film-sized press. The puddle-sized press may be configured as having horizontal, vertical, or inclined rollers. The film-sized press may include a metering system, such as gate-roll metering, blade metering, Meyer rod metering, slot metering, etc. For some examples, a film-sized press with short-dwell blade metering may be used as an application head to apply a coating solution.

### Primer Layers

As mentioned, a primer layer can be applied to a back side of the cellulose-based substrate. The primer layer can be, for example, in the form of a continuous film including styrene-butadiene copolymer with moisture-repellant particles dispersed therein. The primer layer can be applied so that it is devoid of large pinholes, e.g., no more than about 1.5% of the surface area includes pinhole voids. Various styrene-butadiene copolymers can be particularly useful because they can collapse from a 3D spherical shape as polymer particles to a very thin continuous (2D) film with thickness from 0.5 μm to 15 μm, from 1 μm to 15 μm, from 2 μm to 15 μm, from 2 μm to 8 μm, or from 3 μm to 8 μm, for example, under moderate temperatures, e.g., 80° C. to 150° C. The primer layer can be applied by any of a number of analog application processes. For example, application can be by use of an analog coating process including rollers, blade coating apparatus, Meyer rod coater, slot coating apparatus, curtain or blanket coating apparatus, or the like.

Styrene-butadiene copolymer with molar ratios of styrene to butadiene moieties can be used, but particularly, a molar ratio of styrene to butadiene moieties can be from 1:3 to 3:1, from 7:13 to 7:3, or from 2:3 to 3:2. Styrene-butadiene copolymer is useful in this context as it has a low polarity and moisture vapor transmission rate while keeping good film-forming properties. Certain styrene butadiene copolymers can be made using low critical micelle concentration (cmc) of surfactant so that water absorption is further reduced. Examples of such styrene-butadiene copolymer that can be used include Tytoke® 6160, Tytoke® 1019, Tytoke® 4119, Tytoke® 1004 from Mallard Creek Polymers Inc., USA. There are others that can likewise be used from other vendors as well.

The primer layer and/or the hydrophobic moisture barrier (described hereinafter in greater detail) can provide “low moisture absorption” or can be referred to as including components that are “moisture-resistant,” which both indicate that the hydrophobic character of the primer layer or hydrophobic moisture barrier has the tendency to repel, block, or resist absorption of aqueous water in normal condition.

More specifically, the term “low moisture absorption” is intended to refer to layers having a Cobb value from 0.01 grams per square meter (“gsm”) to 8 gsm, or from 0.1 gsm to 5 gsm, for example, as measured using the standard Cobb sizing (TAPPI method T-441) with a 2 minute test time. In summary, the Cobb values determined using this methodology related to the absorption of water (in grams per square meter) within 120 seconds. Thus, a Cobb value of 4 gsm indicates that within 120 seconds, 4 grams of water per square meter area is absorbed into the print medium via contact with the primer layer. Thus, a lower number indicates more water was kept out, which is better with respect to water repellency. As a note, the Cobb value for an example cellulose-based substrate with fixative sizing layer (but no back side coatings and/or barriers applied) may be about 30 to 40 gsm in some instances. Furthermore, by including the primer layer and the hydrophobic moisture barrier described in greater detail hereinafter, Cobb values or Cobb resistance can be reduced further compared to that of instances where the primer layer is applied without the additional protection provided by the hydrophobic moisture barrier. Bringing Cobb values (or Cobb water resistance) down to about 10 gsm or less, e.g., from 0 to 10, from 0.1 to 10, from 0.1 to 5, from 0.2 to 4, etc., provides a good advancement over uncoated print media, for example.

In another example, the primer layer and/or the hydrophobic moisture barrier (described in further detail below) can also be characterized as being “moisture-resistant” as measured by its moisture vapor transmission rate (MVTR), as measured using a standard moisture vapor transmission rate protocol (TAPPI method T-448). The method is a gravimetric determination of the water vapor transmission rate of sheet materials at 37.8° C. (100° F.) with an atmosphere of 90% RH on one side and a desiccant on the other.

Returning now more specifically to details about the primer layer, in addition to the styrene-butadiene copolymer film that is included in the primer layer (applied to the back side of the cellulose-based substrate), the primer film can provide a continuous layer where “moisture-repellant particles” can be dispersed homogenously and blended throughout the matrix of the styrene-butadiene copolymer film to further impact the effectiveness of low moisture absorption (Cobb value) and moisture vapor transmission rate (MVTR). Further, to extend the effectiveness of reduced moisture vapor transmitting rate by bringing the moisture vapor penetration path from direct point to point, to an indirect path between points, as well as increasing the blocking effectiveness to moisture vapor, and to in some instances enhancing surface smoothness, moisture-repellant particles can be included in the primer layer in a larger ratio over matrix of the styrene-butadiene copolymer. Examples of such moisture-repellant particles include inorganic particles, wax particles, or a combination thereof. The moisture-repellant particles can be included in the primer layer at a weight ratio of moisture-repellant particles to styrene-butadiene copolymer from 1:99 to 4:1, from 1:20 to 2:1, from 1:10 to 1:1, or from 1:2 to 4:1, for example. In more specific detail, in some examples, the moisture-repellant particles can be included in the primer layer at from 1 wt % to 15 wt % wax particles, from 1 wt % to 75 wt % inorganic particles, or a combination thereof, based on a total dry weight of the primer layer.

For the purpose of further extending the effectiveness of the reduction of moisture vapor transmission rate, the pathway of moisture vapor getting through the packaging print media can be extended. Thus, rather than moisture penetrating by direct point to point penetration in the z-axis direction into and through the print media, indirect pathways can be introduced by the inclusion of inorganic particles, wax, or moisture-repellant particles. Thus, moisture-repellant particles can provide reduced moisture uptake and/or vapor transmission because of the chemical nature of the primer layer and its components, and/or by introducing particles into the styrene-butadiene film of the primer layer, a more tortious pathway for the moisture vapor may be introduced, thus providing a lower moisture vapor transmission rate (MVTR) due to these pathway-disrupting particles. As an example, in one specific compositional makeup of a primer layer, inorganic particles with high aspect ratio, e.g., 2:1 or greater, from 2:1 to 15:1, from 3:1 to 15:1, from 5:1 to 10:1, or from 4:1 to 8:1, can be introduced into the styrene-butadiene film, even if they are not particularly effective at water absorption on their own. This is because they may still effectively block the moisture vapor pathway and thus reduce the penetration speed of moisture vapor. The aspect ratio can refer to the ratio of average particle size of the width (longest dimension) to the thickness of flake or plate, for example. Suitable inorganic particles include, but are not limited to, aluminum trihydrate, barium sulfate, calcium carbonate, mica (potassium aluminum silicates), silicates (e.g., aluminum silicate), talc (magnesium silicates), bentonite (montmorillonite, smectite), and clay (e.g., high aspect ratio platy clay or kaolin clay). Other examples can include precipitated calcium carbonate (PCC), ground calcium carbonate (GCC), titanium dioxide, mica, silica, boehmite, and/or the like. The D50 particle size of the inorganic particulates can be, for example, from 100 nm to 15 μm, from 200 nm to 10 μm, from 350 nm to 5 μm, or from 500 nm to 2 μm.

“D50” particle size is defined as the particle size at which about half of the particles are larger than the D50 particle size and about half of the other particles are smaller than the D50 particle size (by weight based on the particle content). As used herein, particle size with respect to any of the particles herein can be based on volume of the particle size normalized to a spherical shape for diameter measurement, for example. Particle size can be collected using a Malvern ZETASIZER™ from Malvern Panalytical (United Kingdom), for example. Likewise, the “D95” is defined as the particle size at which about 5 wt % of the particles are larger than the D95 particle size and about 95 wt % of the remaining particles are smaller than the D95 particle size.

As mentioned, in other examples, the moisture-repellant particles can include wax particles, such as waxes of polyethylene, polypropylene, paraffin, or the like. If wax is included, the dry weight of wax to styrene-butadiene film can be from 1:99 to 1:5, from 1:50 to 1:10, or from 1:20 to 1:8. The selection of wax dispersion can be from any of a number of vendors, but example waxes that can be used include Sequapel® 409, Sequapel® 414 and Sequapel® 417, all available from Omnava Inc. (USA).

### Hydrophobic Moisture Barriers

In further detail, a hydrophobic moisture barrier can be applied to the primer layer. The hydrophobic moisture barrier can be, for example, the outermost layer on the back side of the packaging print medium (the non-imaging side). This barrier can provide a strong surface that is able to further block moisture and vapor penetration. The thickness of this layer can range from 0.5 μm to 10 μm, from 1 μm to 10 μm, from 2 μm to 10 μm, from 2 μm to 8 μm, from 1 μm to 3 μm, or from 3 μm to 8 μm, for example. The dry basis weight can be about the same numerically, e.g., from 0.5 gsm to 10 gsm, from 2 gsm to 10 gsm, from 2 gsm to 8 gsm, from 1 gsm to 3 gsm, or from 3 gsm to 8 gsm. The hydrophobic moisture barrier can be applied by any of a number of analog application processes. For example, application can be by use of an analog coating process including rollers, blade coating apparatus, Meyer rod coater, slot coating apparatus, curtain or blanket coating apparatus, or the like. In some examples, the transparent abrasion-resistant layer can be cured by IR radiation, heated oven, ambient air, and/or forced air.

The material used to construct the hydrophobic moisture barrier can include compounds that enhance hydrophobicity of the barrier and/or further resist moisture or vapor penetration into the packaging print media. The hydrophobic moisture barrier can have a hydrophobicity that can be measured using techniques such as contact angle (with water), which can be correlated with surface energy (of the surface) or surface tension (of the liquid on the surface).

In some examples, the hydrophobic moisture barrier can include a compound such as an organic fluorocarbon, such as a fluorocarbon having a hydrocarbon polymer backbone. Examples may include polyamides, polyesters, or polyurethanes with appended fluorinated C1 to C8 alkyl chains or rings, for example. In some examples, the short chains or rings may be C4 to C6. In certain examples, the fluorinated alkyl chains or rings can be C4 or C6 alkyl chains or rings. More specific examples may include poly(fluorooxetane), acrylate-modified poly(fluorooxetane), perfluorooctane sulfonate (PFOS), perfluorooctanoic acid (PFOA), or the like.

In another example, the hydrophobic moisture barrier can include silicone-based compounds. These compounds may be used as aqueous emulsions prepared by dispersing silicone oil in water using an emulsifier. A silicone-based compound that may be used can be from the class of polymeric polydialkylsiloxanes, with one specific example including polydimethylsiloxane. In other examples, polydialkylsiloxanes can be selected from polymethylhydrosiloxane, hydromethyl polysiloxane, dimethyl polysiloxane, hydromethyl-dimethyl polysiloxane, polyhexamethyl disiloxane, polyecamethyl tetrasiloxane, polydodecamethyl pentasiloxane, polyoctamethyl trisiloxane, polyoctamethyl cyclotetrasiloxane, polydodecamethyl cyclohexasiloxane, polydecamethyl cyclopentasiloxane, or a combination thereof. Example commercial products that can be used for the hydrophobic moisture barrier include Wacker® AK 350, Wacker® AK 1000, Wacker® HC 103, Wacker® HC 303, and/or Wacker® Finish WS 60E, all from Wacker Co. (Germany).

In another example, the hydrophobic moisture barrier can include moisture-repellant film with low moisture vapor transmission rates (MVTR) and/or low moisture absorption (Cobb), including a polymer or copolymer of acrylate and methacrylate. For example, the hydrophobic moisture barrier can be applied on the primer layer on the back side of the packaging print media, and the two layers together (primer layer and hydrophobic moisture barrier) can have a Cobb value, as measured by TAPPI method T-441, from 0.01 to 3, from 0.01 to 2.5, from 0.01 to 2, from 0.01 to 1.5, from 0.08 to 1, or from 0.25 to 0.6 (gsm), e.g., grams per square meter of absorbed water absorbed within 120 seconds. Furthermore, the hydrophobic moisture barrier can also have a moisture vapor transmission rate (MVTR) from 100 to 5, from 80 to 20, or from 50 to 30, for example, as measured by the standard TAPPI method T-464.

In one example, the moisture-repellant film can be a poly octadecyl acrylate. Example polyacrylate based polymers can include polymers made by hydrophobic addition monomers including, but are not limited to, C1-C12 alkyl acrylate and methacrylate (e.g., methyl acrylate, ethyl acrylate, n-propyl acrylate, isopropyl acrylate, n-butyl acrylate, isobutyl acrylate, sec-butyl acrylate, tert-butyl acrylate, 2-ethylhexyl acrylate, octyl acrylate, methyl methacrylate, ethyl methacrylate, n-propyl methacrylate, isopropyl methacrylate, n-butyl methacrylate, isobutyl methacrylate, sec-butyl methacrylate, tert-butyl methacrylate), and aromatic monomers (e.g., styrene, phenyl methacrylate, o-tolyl methacrylate, m-tolyl methacrylate, p-tolyl methacrylate, benzyl methacrylate), hydroxyl containing monomers (e.g., hydroxyethylacrylate, hydroxyethylmthacrylate), carboxylic containing monomers (e.g., acrylic acid, methacrylic acid), vinyl ester monomers (e.g., vinyl acetate, vinyl propionate, vinylbenzoate, vinylpivalate, vinyl-2-ethylhexanoate, vinylversatate), vinyl benzene monomer, C1-C12 alkyl acrylamide and methacrylamide (e.g., t-butyl acrylamide, sec-butyl acrylamide, N,N-dimethylacrylamide), crosslinking monomers (e.g., divinyl benzene, ethyleneglycoldimethacrylate, bis(acryloylamido)methylene), or combinations thereof. Polymers made from the polymerization and/or copolymerization of alkyl acrylate, alkyl methacrylate, vinyl esters, and styrene derivatives may also be useful. In one example, the moisture-repellant film can be a copolymer of methacrylate acrylate and butyl acrylate in a molecular ratio of two monomers of 4:1. In one example, the polyacrylate based polymer can include polymers having a glass transition temperature from 20° C. to 60° C., from 30° C. to 50° C., or from 30° C. to 40° C. In another example, the polyacrylate based polymer can include polymers having a glass transition temperature of less than 40° C.

In other example, the hydrophobic moisture barrier may include a wax, such as polyolefin wax. Example polyolefin waxes that can be used include, for example, a polyethylene wax, a polypropylene wax, a copolymer of ethylene and propylene, a copolymer of ethylene and propylene with C4 to C8 alpha-olefin sidechains, paraffinic wax, or a combination thereof. In some examples, the polyolefin wax can be applied with a polyethylene-based dispersion, a polypropylene-based dispersion, or a dispersion of copolymer of ethylene and propylene with alpha-olefins as butene, hexene, or octene, with the alpha-olefins present as the short side-chain pendent groups on the polyethylene or polypropylene backbones. The D50 particle size of these or other similar particles that may be present can be from 0.1 μm to 50 μm, from 5 μm to 50 μm, or from 10 μm to 25 μm, for example. When the hydrophobic moisture barrier layer is formed, these wax particles can be dispersed or homogenously blended as non-continuous phase throughout the moisture-repellant film. The molecular weight (or the weight average molecular weight) of these or other wax particles can be from 50,000 Daltons to 300,000 Daltons, from 75,000 Daltons to 250,000 Daltons, or from 100,000 Daltons to 200,000 Daltons.

Some specific examples of the polyethylene-based wax include polyethylene (e.g., Michem® Wax 410), an anionic polyethylene wax emulsion (e.g., Michem® Emulsion 52830, Michem® Lube 103DI, and Michem® Lube 190), an anionic polyethylene wax dispersion (e.g., Michem® Guard 7140), a non-ionic polyethylene wax dispersion (e.g., Michem® Guard 25, Michem® Guard 55, Michem® Guard 349, and Michem® Guard 1350) a non-ionic polyethylene wax emulsion (e.g., Michem® Emulsion 72040), or a high melt polyethylene wax dispersion (e.g., Slip-Ayd® SL 300, Elementis Specialties, Inc., Hightstown, N.J.). In some other examples, the thermoplastic material(s) may be an anionic paraffin/ethylene acrylic acid wax emulsion (e.g., Michem® Emulsion 34935), a cationic water based emulsion of polyolefin waxes (e.g., Michem® Emulsion 42035A), anionic microcrystalline wax emulsions (e.g., Michem® Lube 124 and Michem® Lube 124H), or a high density polyethylene/copolymer non-ionic wax emulsion (e.g., Ultralube® E-530V).

In some examples, the hydrophobic moisture barrier can include moisture-repellant film selected from copolymer acrylate-based polymer. Examples may include styrene-acrylic copolymer, styrene-acrylic-acrylonitrile copolymer, or may be selected from polyester polymer such as polyethylene terephthalate (PET), polyurethane, polyamide (nylon) polymer, ethylene-co-polyvinyl alcohol copolymer, polyvinylidene chloride (PVDC), ethylene copolymer resin dispersion, styrene-butadiene copolymer, and chemical modified starches. These dispersed particles and others can be obtained from various commercial suppliers.

The moisture-repellant particles can be dispersed in the moisture-repellant film at a dry weight ratio of moisture-repellant film to moisture-repellant particles dispersed therein at a dry weight ratio from 1:3 to 20:1, from 1:2 to 15:1, from 1:1 to 10:1, or from 1:2 to 5:1, for example. D50 particle sizes of these or other particles dispersed in the hydrophobic moisture barrier can be from 0.1 μm to 1.5 μm, from 0.3 μm to 1.0 μm, or from 0.5 μm to 0.8 μm, for example.

### Ink Compositions

Ink compositions can be used to apply printed matter or printed indicia onto the fixative sizing layer. Ink compositions with colorant may crash with the multivalent metal salt when the ink composition is applied to the primer layer. The ink composition can be, for example, a pigment- or dye-based ink composition, but in one example, is a pigment-based ink composition. In some examples, the pigment-based ink compositions can include a latex binder. The ink compositions, for example, can be aqueous inkjet ink compositions. In further detail, the ink compositions can be adapted for use in high speed printing applications, using equipment like the HP® PageWide printer or an HP® Web Press printer, e.g., T400 HD series printer, or the like.

The ink compositions can include the colorant, and in some instances, other dispersed particles, as mentioned, but also can include an aqueous liquid vehicle. As used herein, the term “aqueous liquid vehicle” includes water and any of a variety of other components. Examples include organic cosolvent, surfactant, buffer, antimicrobial agent, anti-kogation agent, chelating agent, buffer, etc. In an example, the aqueous liquid vehicle can include water and an organic cosolvent. In another example, the aqueous liquid vehicle can include water, organic cosolvent, and a surfactant. The aqueous liquid vehicle can include water that may be deionized, for example. In one example, water can be present at from 40 wt % to 93 wt %, from 50 wt % to 80 wt %, from 60 wt % to 90 wt %, from 60 wt % to 95 wt %, or from 55 wt % to 85 wt %, for example.

Some examples of organic cosolvent(s) that may be added to the aqueous liquid vehicle can include ethanol, methanol, propanol, acetone, tetrahydrofuran, hexane, 1-butanol, 2-butanol, tert-butanol, isopropanol, propylene glycol, methyl ethyl ketone, dimethylformamide, 1,4-dioxone, acetonitrile, 1,2-butanediol, 1-methyl-2,3-propanediol, 2-pyrrolidone, glycerol, 2-phyenoxyethanol, 2-phenylethanol, 3-phenylpropanol, or a combination thereof. Whether a single organic cosolvent is included or a combination of organic cosolvents are included, a total amount of organic cosolvent(s) in the dispersant or the ink composition can range from 2 wt % to 50 wt %, from 2 wt % to 15 wt %, from 10 wt % to 25 wt %, from 25 wt %, to 50 wt %, or from 5 wt % to 12 wt %, based on a total weight of the pigment dispersion or the ink composition.

The aqueous liquid vehicle may also include surfactant. The surfactant can include a non-ionic surfactant, a cationic surfactant, and/or an anionic surfactant. Example non-ionic surfactants that can be used include self-emulsifiable, nonionic wetting agents based on acetylenic diol chemistry (e.g., SURFYNOL® SEF from Air Products and Chemicals, Inc., USA), a fluorosurfactant (e.g., CAPSTONE® fluorosurfactants from DuPont, USA), or a combination thereof. In other examples, the surfactant can be an ethoxylated low-foam wetting agent (e.g., SURFYNOL® 440, SURFYNOL® 465, or SURFYNOL® CT-111 from Air Products and Chemical Inc., USA) or an ethoxylated wetting agent and molecular defoamer (e.g., SURFYNOL® 420 from Air Products and Chemical Inc., USA). Still other surfactants can include wetting agents and molecular defoamers (e.g., SURFYNOL® 104E from Air Products and Chemical Inc., USA), alkylphenylethoxylates, solvent-free surfactant blends (e.g., SURFYNOL® CT-211 from Air Products and Chemicals, Inc., USA), water-soluble surfactant (e.g., TERGITOL® TMN-6, TERGITOL® 1557, and TERGITOL® 1559 from The Dow Chemical Company, USA), or a combination thereof. In other examples, the surfactant can include a non-ionic organic surfactant (e.g., TEGO® Wet 510 from Evonik Industries AG, Germany), a non-ionic secondary alcohol ethoxylate (e.g., TERGITOL® 15-S-5, TERGITOL® 15-S-7, TERGITOL® 15-S-9, and TERGITOL® 15-S-30 all from Dow Chemical Company, USA), or a combination thereof. Example anionic surfactants can include alkyldiphenyloxide disulfonate (e.g., DOWFAX® 8390 and DOWFAX® 2A1 from The Dow Chemical Company, USA), and oleth-3 phosphate surfactant (e.g., CRODAFOS™ N3 Acid from Croda, UK). Example cationic surfactant that can be used can include dodecyltrimethylammonium chloride, hexadecyldimethylammonium chloride, or a combination thereof. In some examples, the surfactant (which may be a blend of multiple surfactants) may be present in the ink composition at an amount ranging from 0.01 wt % to 2 wt %, from 0.05 wt % to 1.5 wt %, or from 0.01 wt % to 1 wt %.

In some examples, the aqueous liquid vehicle may further include a chelating agent, an antimicrobial agent, a buffer, or a combination thereof. While an amount of these may vary, if present, these can be present in the pigment dispersion or the ink composition at a total amount ranging from 0.001 wt % to 20 wt %, from 0.05 wt % to 10 wt %, or from 0.1 wt % to 5 wt %.

The aqueous liquid vehicle may include a chelating agent. Chelating agent(s) can be used to minimize or to eliminate the deleterious effects of heavy metal impurities. Examples of suitable chelating agents can include disodium ethylene-diaminetetraacetic acid (EDTA-Na), ethylene diamine tetra acetic acid (EDTA), and methyl-glycinediacetic acid (e.g., TRILON® M from BASF Corp., Germany). If included, whether a single chelating agent is used or a combination of chelating agents is used, the total amount of chelating agent(s) in the pigment dispersion or the ink composition may range from 0.01 wt % to 2 wt % or from 0.01 wt % to 0.5 wt %.

The aqueous liquid vehicle may also include antimicrobial agent. Antimicrobial agents can include biocides and/or fungicides. Example antimicrobial agent that can be used include NUOSEPT® (Ashland Inc., USA), VANCIDE® (R.T. Vanderbilt Co., USA), ACTICIDE® B20 and ACTICIDE® M20 (Thor Chemicals, U.K.), PROXEL® GXL (Arch Chemicals, Inc., USA), BARDAC® 2250, 2280, BARQUAT® 50-65B, and CARBOQUAT® 250-T, (Lonza Ltd. Corp., Switzerland), KORDEK® MLX (The Dow Chemical Co., USA), or a combination thereof. In an example, if included, a total amount of antimicrobial agents in the pigment dispersion or the ink composition agent can range from 0.01 wt % to 1 wt %.

In some examples, an aqueous liquid vehicle may further include a buffer. The buffer can withstand small changes (e.g., less than 1) in pH when small quantities of a water-soluble acid or a water-soluble base are added to a composition containing the buffer. The buffer can have pH ranges from 5 to 9.5, from 7 to 9, or from 7.5 to 8.5. In some examples, the buffer can include a poly-hydroxy functional amine. In other examples, the buffer can include potassium hydroxide, 2-[4-(2-hydroxyethyl) piperazin-1-yl] ethane sulfonic acid, 2-amino-2-(hydroxymethyl)-1,3-propanediol (TRIZMA® sold by Sigma-Aldrich, USA), 3-morpholinopropanesulfonic acid, triethanolamine, 2-[bis-(2-hydroxyethyl)-amino]-2-hydroxymethyl propane-1,3-diol (bis tris methane), N-methyl-D-glucamine, N,N,N′N′-tetrakis-(2-hydroxyethyl)-ethylenediamine and N,N,N′N′-tetrakis-(2-hydroxypropyl)-ethylenediamine, beta-alanine, betaine, or mixtures thereof. In yet other examples, the buffer can include 2-amino-2-(hydroxymethyl)-1,3-propanediol (TRIZMA® sold by Sigma-Aldrich, USA), beta-alanine, betaine, or mixtures thereof.

### Transparent Abrasion-Resistant Layers

After application of the printed ink composition, a transparent abrasion-resistant layer can be applied to protect the printed ink composition from scratches or other abrasive damage that may occur during use. The transparent abrasion-resistant layer can also provide other benefits in some instances, such as providing added gloss to the packaging print medium, providing more gloss uniformity between printed locations and unprinted location, stain resistance, burnish or scuff resistance, resistance to discoloration from absorption of impurities in the environment, and/or the like. For example, a printed color may have a gloss value and the printed side as a whole may have an average gloss value that is different. Application of the transparent abrasion-resistant layer can both increase gloss and provide a more uniform gloss value from color to color, color to unprinted areas, etc. Gloss can be measured, for example, using a BYK Gardner Gloss Meter at 75°. Various colors can be evaluated, such as black, cyan, magenta, yellow, red, green, and/or blue, as well as the unprinted packaging print medium portions. Higher ink densities can sometimes lead to reduced gloss, for example, and the transparent abrasion-resistant layer can provide some additional gloss to the image, for example. In one example, the gloss level of the printed image or the average gloss level of the printed packaging print medium (from the imaging side) can be brought to greater than 65%, greater than 70%, greater than 75%, or greater than 80%.

In further detail, as this layer is described as being “transparent,” this includes layers where the printed image is visible through the layer with a loss of gamut volume from 0% to 5%, or from 0% to 2%, for example. In other words, “transparent” refers to coating compositions applied at coating thicknesses where there is no more than a 5% decrease in average color gamut of the printed image, and in some instances, no more than a 2% decrease in average color gamut of the printed image.

In some examples, the transparent abrasion-resistant layer can be applied by any of a number of analog application processes. For example, application can be by use of an analog coating process including rollers, blade coating apparatus, Meyer rod coater, slot coating apparatus, curtain or blanket coating apparatus, or the like. The transparent abrasion-resistant layer can be applied using a coating composition that is organic solvent-based or water-based, and in some instances, can be heat or radiation curable. In other examples, the transparent abrasion-resistant layer can be dried in ambient conditions or can be dried with forced air.

The transparent abrasion-resistant layer can include, for example, polyacrylate-based polymer, polymethacrylate-based polymer, wax, or a combination thereof. In one example, the transparent abrasion-resistant layer can be an aqueous-based coating formulation including a polyacrylate such as, but not limited to, homopolymers and/or copolymers of poly(benzyl acrylate), poly(butyl acrylate) (s), poly(2-cyanobutyl acrylate), poly(2-ethoxyethyl acrylate), poly(ethyl acrylate), poly(2-ethylhexyl acrylate), poly(fluoromethyl acrylate), poly(heptafluoro-2-propyl acrylate), poly(heptyl acrylate), poly(hexyl acrylate), poly(isobornyl acrylate), poly(isopropyl acrylate), poly(3-methoxybutyl acrylate), poly(methyl acrylate), poly(nonyl acrylate), poly(octyl acrylate), poly(propyl acrylate), and/or the like.

In another example, the transparent abrasion-resistant layer can include, for example, homopolymers and/or copolymers of methacrylic monomer, such as poly(benzyl methacrylate), poly(octyl methacrylate), poly(butyl methacrylate), poly(2-chloroethyl methacrylate), poly(2-cyanoethyl methacrylate), poly(dodecyl methacrylate), poly(2-ethylhexyl methacrylate), poly(ethyl methacrylate), poly(1,1,1-trifluoro-2-propyl methacrylate), poly(hexyl methacrylate), poly(2-hydroxyethyl methacrylate), poly(2-hydropropyl methacrylate), poly(isopropyl methacrylate), poly(methacrylic acid), poly(methyl methacrylate) in various forms (such as atactic, isotactic, syndiotactic, or heterotactic), and/or poly(propyl methacrylate).

In further detail, if a wax is included, the wax can be a polyethylene or polypropylene wax, for example. Some specific examples of the polyethylene-based wax include polyethylene (e.g., Michem® Wax 410), an anionic polyethylene wax emulsion (e.g., Michem® Emulsion 52830, Michem® Lube 103DI, and Michem® Lube 190), an anionic polyethylene wax dispersion (e.g., Michem® Guard 7140), a non-ionic polyethylene wax dispersion (e.g., Michem® Guard 25, Michem® Guard 55, Michem® Guard 349, and Michem® Guard 1350) a non-ionic polyethylene wax emulsion (e.g., Michem® Emulsion 72040), or a high melt polyethylene wax dispersion (e.g., Slip-Ayd® SL 300, Elementis Specialties, Inc., Hightstown, N.J.). In some other examples, the thermoplastic material(s) may be an anionic paraffin/ethylene acrylic acid wax emulsion (e.g., Michem® Emulsion 34935), a cationic water based emulsion of polyolefin waxes (e.g., Michem® Emulsion 42035A), anionic microcrystalline wax emulsions (e.g., Michem® Lube 124 and Michem® Lube 124H), or a high density polyethylene/copolymer non-ionic wax emulsion (e.g., Ultralube® E-530V). Again, if wax is used, or any other polymer, at the thickness applied, the abrasion-resistant layer applied can be “transparent” as defined herein, e.g., no more than a 5% decrease in average color gamut of the printed image occurs as a result of the applied transparent abrasion-resistant layer.

Some commercially available aqueous coating compositions that can be used include overprint varnishes, such as DigiGuard® 5201J from Michelman (USA); Purekote® DP9500, Purekote® DP9510, Purekote® DP9560, Purekote® DP9610 from Ashland Inc. (USA); and/or Overprint® KS-117, Overprint® KS-190, Overprint® KS-1108, Overprint® KS-191, Overprint® KS-110, Overprint® KS-197, Overprint® KS-104, or Overprint® KS-151 from Kustom Group (USA). In other examples, transparent abrasion-resistant layers can be UV-based, and include products such as HiPrint® FLX 401, HiPrint® FLX 402, or HiPrint® FLX 403 from Cyteck Inc. (Germany). In certain examples, the transparent abrasion-resistant layer can include, for example, various polyacrylate-based polymers that are also transparent as defined herein, such as INXKote® AC9116 from INX Int. Ink (USA), Aquaflex® H.R. from Flint Group (Luxembourg), or a combination thereof.

### Methods of Preparing Packaging Print Media and Methods of Printing

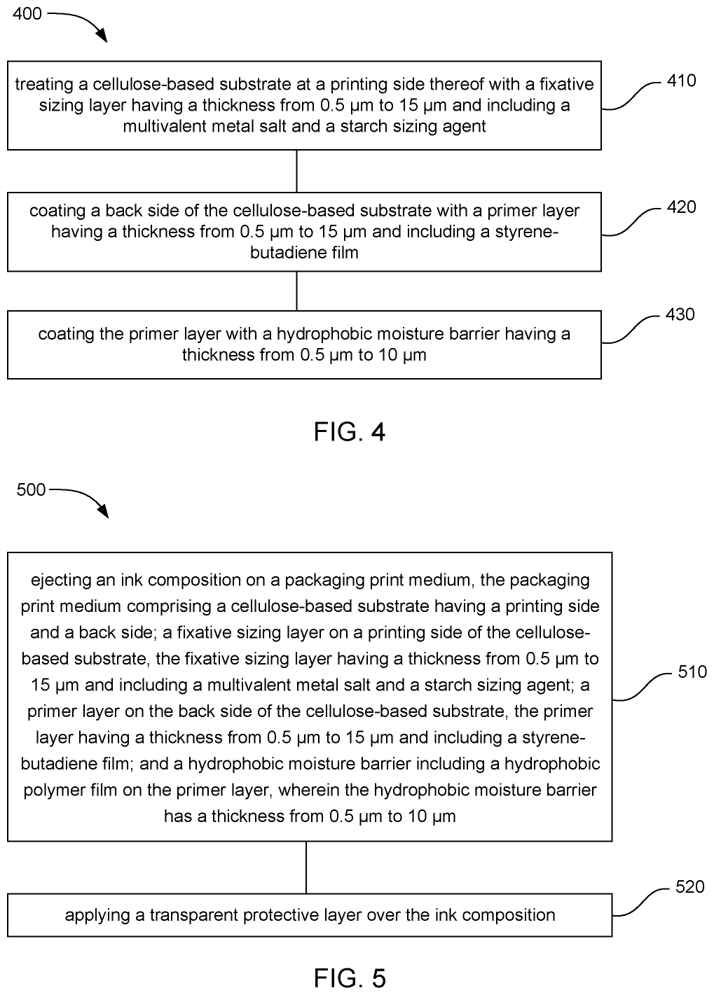

Methods of preparing a packaging print medium are also included in the present disclosure as illustrated by the flow chart in FIG. 4. In one example, the method 400 can include treating 410 a cellulose-based substrate at a printing side thereof with a fixative sizing layer having a thickness from 0.5 μm to 15 μm and including a multivalent metal salt and a starch sizing agent, and coating 420 a back side of the cellulose-based substrate with a primer layer having a thickness from 0.5 μm to 15 μm and including a styrene-butadiene film with moisture-repellant particles dispersed therein. The method in this example can further include coating 430 the primer layer with a hydrophobic moisture barrier having a thickness from 0.5 μm to 10 μm and including a hydrophobic polymer film. In one example, the method can include printing an ink composition on the printing side to contact the fixative sizing layer, and in some examples, the method can further include applying a transparent protective layer over the ink composition.

In another example, as shown in FIG. 5, a method 500 of printing can include ejecting 510 an ink composition on a packaging print medium and applying 520 a transparent protective layer over the ink composition. The packaging print medium in this example includes a cellulose-based substrate having a printing side and a back side, a fixative sizing layer on a printing side of the cellulose-based substrate, a primer layer on the back side of the cellulose-based substrate, and a hydrophobic moisture barrier including a hydrophobic polymer film on the primer layer. The fixative sizing layer in this example has a thickness from 0.5 μm to 15 μm and includes a multivalent metal salt and a starch sizing agent. The primer layer in this example has a thickness from 0.5 μm to 15 μm and includes a styrene-butadiene film with moisture-repellant particles dispersed therein. The hydrophobic moisture barrier in this example has a thickness from 0.5 μm to 10 μm. In one example, the ink composition can be a pigment-based ink composition including a pigment colorant that is reactive with the multivalent salt of the fixative sizing layer. In another example, the transparent abrasion-resistant layer can include, for example, various polyacrylate-based polymers that are also transparent as defined herein, such as INXKote® AC9116 from INX Int. Ink (USA), Aquaflex® H.R. from Flint Group (Luxembourg), or a combination thereof.

### Definitions

It is noted that, as used in this specification and the appended claims, the singular forms “a,” “an,” and “the” include plural referents unless the context clearly dictates otherwise.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also to include individual values and sub-ranges within the indicated range. Thus, included in this numerical range are individual values such as 2, 3.5, and 4 and sub-ranges such as from 1-3, from 2-4, and from 3-5, etc. Additionally, a numerical range with a lower end of “0” can include a sub-range using “0.1” as the lower end point.

### EXAMPLES

The following illustrates some examples of various packaging print media as well as methods associated therewith in accordance with the present disclosure. However, it is to be understood that the following are only examples or are illustrative of applications of the present disclosure. Numerous modifications and alternative compositions, substrates, layers, barriers, treatments, systems, methods, etc., may be devised without departing from the scope of the present technology.

### Example 1—Preparation and Evaluation of Primer Layer Samples

Several media samples were prepared in accordance with the following methodologies. A front (printing) side of a 50 #cellulose-based substrate was coated with a fixative coating composition to leave a 1.5 gsm fixative sizing layer thereon. The fixative sizing layer included a starch sizing agent and calcium chloride (multivalent metal salt) at a 2:1 weight ratio, leaving 1 gsm starch and 0.5 gsm calcium chloride applied to the cellulose-based substrate. The coating thickness was about 1 μm.

A back side of the cellulose-based substrate was coated with a primer coating composition using an analog coating device to leave a primer layer. The primer layer can be applied at a thickness from 0.5 μm to 15 μm, for example, but in the following examples, the primer layer was applied at 5 gsm or 10 gsm (at approximate thickness of 4-5 μm or 8-10 μm, respectively). Example primer layers as applied are shown in Table 1, as follows:

TABLE 1
Primer layers and Properties

| | Primer layers (Dry Weight) | | | | |
|---|---|---|---|---|---|
| | P1 | P2 | P3 | P4 | P5 |
| Component | (wt %) | (wt %) | (wt %) | (wt %) | (wt %) |
| Styrene-butadiene | 100 | — | — | 95.2 | 64.5 |
| Copolymer | | | | | |
| (Tg 12° C.) | | | | | |
| Ethylene-vinyl Acetate | — | 100 | — | — | — |
| (Tg 16° C.) | | | | | |
| Ethylene-vinyl Acetate | — | — | 100 | — | — |
| (Tg 52° C.) | | | | | |
| Polyethylene Wax | — | — | — | 4.8 | 3.2 |
| Particles | | | | | |
| Calcined Kaolin | — | — | — | — | 32.3 |
| Clay Particles | | | | | |

Primer Layer Properties

| | | | | | |
|---|---|---|---|---|---|
| Film Quality | Good | Good | Poor | Good | Good |
| | | | (Cracked) | | |
| Dry Basis | 5 | 10 | 10 | 10 | 10 |
| Weight (gsm) | | | | | |
| Thickness (μm) | 4-5 | 8-10 | 8-10 | 8-10 | 8-10 |
| Cobb Value* (gsm) | 4 | 24.3 | 34.6 | 3.3 | 1.8 |

In this example and elsewhere herein:
“Film Quality” is reported as “Good” or “Poor” based on whether or not the layer could be applied as a continuous film and did not crack upon being cured or dried.
“Dry Basis Weight” is based on a total weight of the dry components after the volatile liquids, such as water, have been dried or removed therefrom to leave a dry film with dispersed particles where applicable. Dry basis weight can be expressed in grams per square meter, or “gsm.”
“Cobb Value” is determined using TAPPI method T-441, which relates to the absorption of water within 30 seconds. Thus, a Cobb value of 4 indicates that within 30 seconds, 4 gsm of water is absorbed into the media when applied to the respective primer layer. Thus, a lower number indicates more water was kept out, which is better in this instance with respect to water repellency.

Notably, the Cobb value for P1, P4, and P5 were the best. The Cobb value for cellulose-based substrate with fixative sizing layer (but no back coatings) was determined to be 35.1. Thus, ethylene-vinyl acetate primer layer application of P3 did not improve the water repellency over uncoated media samples, and primer layer P2 (with a different ethylene-vinyl acetate polymer) improved the water-repellency to some degree, but not to an extent that it was as effective as the styrene-butadiene copolymer primer layer. Thus, it appears that styrene-butadiene film provides superior water repellency compared to the ethylene-vinyl acetate comparable examples. As a further note, in this example, by dispersing moisture-repellant particles in the styrene-butadiene film of the primer layer, further favorable anti-moisture properties can be introduced.

### Example 2—Preparation and Evaluation of Packaging Print Media Samples

As primer layers P1, P4, and P5 had the lowest Cobb values, various styrene-butadiene copolymer-based primer layers were applied on the back side of a 50 #cellulose-based paper substrate including the fixative sizing layer described in Example 1, followed by various hydrophobic moisture barrier formulations. On one sample, the cellulose-based substrate was also coated on the front with a transparent abrasion-resistant layer on the printing side of the media (e.g., to be applied over a fixative sizing layer and a printed image). After application of the various layers as set forth in Table 2 below, water absorption and water permeability data was collected to determine water repellency performance of three samples (Exp1 to Exp3).

TABLE 2
Packaging Print Media Layers and Moisture Resistant Properties

| | | Hydrophobic | Transparent | | |
|---|---|---|---|---|---|
| | | Moisture | Abrasion- | | |
| | Primer Layer | Barrier | resistant Layer | | |
| | (dry basis | (dry basis | (dry basis | Cobb | |
| Exp. | weight; | weight; | weight; | Value | MVTR |
| ID | thickness) | thickness) | thickness) | (gsm) | (g/m²/day) |
| Exp1 | P1 | Vaporcoat ® | — | 0.27 | 56.9 |
| | (5 gsm; | 2200R | | | |
| | 4-5 μm) | (5 gsm; | | | |
| | | 4-5 μm) | | | |
| Exp2 | P1 | Vaporcoat ® | — | 0.52 | 88.1 |
| | (10 gsm; | 2200R | | | |
| | 8-10 μm) | (5 gsm; | | | |
| | | 4-5 μm) | | | |
| Exp3 | P1 | Vaporcoat ® | Inxkote ® AC | 0.25 | 76.7 |
| | (10 gsm; | 2200R | 9116 (OPV) | | |
| | 8-10 μm) | (5 gsm; | (5 gsm; | | |
| | | 4-5 μm) | 4-5 μm) | | |

| | | |
|---|---|---|
| Xerox PE Laminated Ream Wrap (Control) | N/A | 83.7 |

Vaporcoat ® 2200R is a low moisture-absorbing polyacrylate-based polymer, available from Michelman (USA).
Inxkote ® AC 9116 is a transparent polyacrylate-based polymer available from Inx Int. Ink (USA).

In this example and elsewhere herein:
“Moisture Vapor Transmission Rate” or “MVTR” can be measured using a protocol (TAPPI method T-448). The method is a gravimetric determination of the water vapor transmission rate of sheet materials at 37.8° C. (100° F.) with an atmosphere of 90% RH on one side and a desiccant on the other.

Various samples (Exp4 and Exp 5) were also prepared to evaluate the benefit of adding moisture-repellant particles to the primer layer, e.g., particles dispersed in the styrene-butadiene film. These samples were prepared to include both the primer layer and the hydrophobic moisture barrier on the back side of 50 #cellulose-based substrate samples, and a transparent abrasion-resistant layer was applied on the front side. The transparent abrasion-resistant layer would normally be applied over a printed image that is applied to the fixative sizing layer, but the fixative sizing layer and printed image was not included in this example to get more precise Cobb values attributable to the primer layer and the hydrophobic moisture barrier. The dry weight basis of the various layers and the data collected is provided in Table 3, as follows:

TABLE 3
Packaging Print Media Layers and Moisture Resistant Properties

| | | Hydrophobic | Transparent | |
|---|---|---|---|---|
| | | Moisture | Abrasion- | Cobb |
| Exp. | Primer Layer | Barrier | resistant Layer | Value |
| ID | (10 gsm) | (10 gsm) | (10 gsm) | (gsm) |
| Exp4 | Styrene-butadiene | Vaporcoat ® | Inxkote ® AC | 1.6 |
| | Copolymer (95.2 wt %) | 2200R | 9116 (OPV) | |
| | Polyethylene | (100 wt %) | (100 wt %) | |
| | Wax (4.8 wt %) | | | |
| Exp5 | Styrene-butadiene | Vaporcoat ® | Inxkote ® AC | 1.8 |
| | Copolymer (64.5 wt %) | 2200R | 9116 (OPV) | |
| | Polyethylene | (100 wt %) | (100 wt %) | |
| | Wax (3.2 wt %) | | | |
| | Calcined Kaolin | | | |
| | Clay (32.3 wt %) | | | |

Vaporcoat ® 2200R is a low moisture-absorbing polyacrylate-based polymer, available from Michelman (USA).
Inxkote ® AC 9116 is a transparent polyacrylate-based polymer available from Inx Int. Ink (USA).

Thus, the introduction of wax particles or both wax particles and inorganic particles to the primer layer provided acceptable Cobb values in both instances. Both Cobb values in Table 2 and Table 3 outperformed the Cobb values provided by Table 1, which included the primer layer but not the hydrophobic moisture barrier as was included in Tables 2 and 3.

While the disclosure has been described with reference to certain examples, those skilled in the art will appreciate that various modifications, changes, omissions, and substitutions can be made without departing from the spirit of the disclosure. It is intended, therefore, that the present disclosure be limited only by the scope of the following claims.

What is claimed is:

1. A packaging print medium, comprising:
a cellulose-based substrate having a printing side and a back side;
a fixative sizing layer on a printing side of the cellulose-based substrate, the fixative sizing layer having a thickness from 0.5 μm to 15 μm and including a multivalent metal salt and a starch sizing agent;
a primer layer on the back side of the cellulose-based substrate, the primer layer having a thickness from 0.5 μm to 15 μm and including a styrene-butadiene film; and
a hydrophobic moisture barrier including a moisture-resistant film on the primer layer, wherein the hydrophobic moisture barrier has a thickness from 0.5 μm to 10 μm.

2. The packaging print medium of claim 1, wherein the multivalent metal salt of the fixative sizing layer includes a Group II metal salt, a Group III metal salt, a transitional metal salt, or a combination thereof.

3. The packaging print medium of claim 1, further comprising moisture-repellant particles dispersed in the styrene-butadiene film, wherein the moisture-repellant particles include from 1 wt % to 15 wt % wax particles, from 1 wt % to 75 wt % inorganic particles, or a combination thereof, based on a total dry weight of the primer layer.

4. The packaging print medium of claim 1, wherein the styrene-butadiene film has a molar ratio of styrene moieties to butadiene moieties from 1:3 to 3:1.

5. The packaging print medium of claim 1, wherein the hydrophobic polymer film includes polymer with C1 to C8 fluorocarbon moieties, polysiloxane, a polyolefin, or a combination thereof.

6. The packaging print medium of claim 1, wherein the hydrophobic moisture barrier also includes moisture-repellant particles dispersed therein at a dry weight ratio from 1:3 to 20:1.

7. The packaging print medium of claim 1, further comprising a transparent abrasion-resistant layer on the fixative sizing layer.

8. The packaging print medium of claim 7, wherein the transparent abrasion-resistant layer includes transparent polyacrylate-based polymer, a transparent polymethacrylate-based polymer, wax, or a combination thereof.

9. The packaging print medium of claim 7, wherein the transparent abrasion-resistant layer is also on an ink composition that is present on the fixative sizing layer.

10. A method of preparing a packaging print medium, comprising:
treating a cellulose-based substrate at a printing side thereof with a fixative sizing layer having a thickness from 0.5 μm to 15 μm and including a multivalent metal salt and a starch sizing agent;
coating a back side of the cellulose-based substrate with a primer layer having a thickness from 0.5 μm to 15 μm and including a styrene-butadiene film; and
coating the primer layer with a hydrophobic moisture barrier having a thickness from 0.5 μm to 10 μm.

11. The method of claim 10, further comprising printing an ink composition on the printing side to contact the fixative sizing layer.

12. The method of claim 11, further comprising applying a transparent protective layer over the ink composition.

13. A method of printing, comprising:
ejecting an ink composition on a packaging print medium, the packaging print medium comprising:
a cellulose-based substrate having a printing side and a back side,
a fixative sizing layer on a printing side of the cellulose-based substrate, the fixative sizing layer having a thickness from 0.5 μm to 15 μm and including a multivalent metal salt and a starch sizing agent,
a primer layer on the back side of the cellulose-based substrate, the primer layer having a thickness from 0.5 μm to 15 μm and including a styrene-butadiene film, and
a hydrophobic moisture barrier including a hydrophobic polymer film on the primer layer, wherein the hydrophobic moisture barrier has a thickness from 0.5 μm to 10 μm; and
applying a transparent protective layer over the ink composition.

14. The method of claim 13, wherein the ink composition is a pigment-based ink composition including a pigment colorant that is reactive with the multivalent salt of the fixative sizing layer.

15. The method of claim 13, wherein the transparent abrasion-resistant layer includes a transparent polyacrylate-based polymer or a transparent polymethacrylate-based polymer.
